(19) United States
(12) Patent Application Publication
(10) Pub. No.: US 2012/0016505 A1
(43) Pub. Date: Jan. 19, 2012

(54) ELECTRONIC AUDIO DEVICE

(76) Inventors: David Gough, Cypress, TX (US); Carlos O. Montalvo, Cupertino, CA (US)

(21) Appl. No.: 13/259,458

(22) PCT Filed: Sep. 14, 2009
(86) PCT No.: PCT/US09/56817

§ 371 Date: Sep. 23, 2011

(51) Int. Cl. G06F 19/00

(52) U.S. Cl. 700/94

(57) ABSTRACT

There is provided an electronic audio device that is adapted to be connected to a speaker. The electronic device comprises an audio subsystem that is adapted to receive an input audio electrical signal. The electronic device comprises an equalizer that is adapted to receive the input audio electrical signal and to apply a transfer function that comprises a two-stage bandpass function thereto to produce an output audio electrical signal, the transfer function being dependent at least in part upon a frequency response of the speaker.

### BACKGROUND

Many contemporary electronic devices are designed to reproduce music and/or other audio signals. These electronic devices, such as, for example, personal computers, laptops, portable audio players, cell phones, etc., typically include an integral audio subsystem that processes the electrical signals representing audio information to be reproduced as audible sound. The audio signals are transformed into audible sound by one or more integral or external electroacoustical transducers or speakers interconnected with the audio subsystem of the electronic device.

Each electroacoustical transducer or speaker has its own set of electrical characteristics and parameters including, for example, frequency response, sensitivity, resonant frequency, damping factor, compliance, etc. The electrical characteristics and parameters of the particular electroacoustical transducer or speaker being used will affect the conversion of the electrical audio signals into audible sound. Thus, different electroacoustical transducers will convert the same electrical audio signal differently. For example, physically smaller electroacoustical transducers, such as headphones, typically have limited capability to reproduce frequencies in the audio bass frequency range (frequencies less than approximately 200 Hz).

The audio subsystems in many electronic devices are exposed to electrical noise and interference from a variety of sources including digital circuitry and signals as well as radio frequency circuitry and signals generated within and by the electronic device, ground loop currents entering the audio signal path, and power source/line noise leaking into the audio signal path. A substantial portion of these electrical interference signals typically fall within the audio frequency range, and specifically within the audio bass frequency range. Thus, audio subsystems that emphasize the audio bass frequency range may also emphasize the undesired electrical interference signals within the bass frequency range and thereby degrade the quality of the reproduced audio.

### BRIEF DESCRIPTION OF THE DRAWINGS

Certain exemplary embodiments are described in the following detailed description and in reference to the drawings, in which:

FIG. 1 is a block diagram of an electronic device having an audio subsystem with an equalization stage according to an exemplary embodiment of the present invention;

FIG. 2 is a block diagram of the equalization stage of FIG. 1;

FIG. 3 illustrates a frequency response curve (gain vs. frequency) applied by the equalization stage of FIG. 1; and

FIG. 4 illustrates a method for modifying an audio signal to possess desired audio characteristics according to an exemplary embodiment of the present invention.

### DETAILED DESCRIPTION OF SPECIFIC EMBODIMENTS

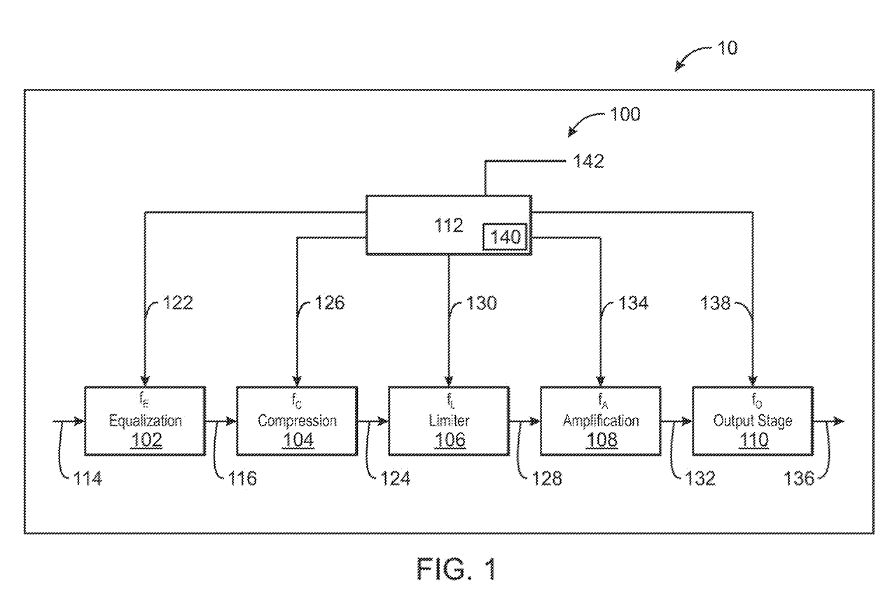

FIG. 1 is a block diagram of an electronic device having an audio subsystem with an equalization stage according to an exemplary embodiment of the present invention. An electronic device 10 includes an audio subsystem 100 which, in turn, includes a plurality of audio processing stages. More particularly, the audio processing stages of electronic device 10 includes an equalization stage 102, a compression stage 104, a limiter stage 106, an amplification stage 108 and an output stage 110. The electronic device 10 further includes a processor or controller 112, which may be part of, integral with or separate from the audio subsystem 100.

Those of ordinary skill in the art will appreciate that the functional blocks and devices shown in the figures are only one example of functional blocks and devices that may be implemented in an exemplary embodiment of the present invention. Moreover, other specific implementations containing different functional blocks may be chosen based on system design considerations.

The equalization stage (EQ stage) 102 performs the process of altering, using passive or active electronic elements or digital algorithms, frequency response characteristics of audio subsystem 100. As used herein, the term “frequency response” refers to an output-to-input ratio of a transducer as a function of frequency.

In the exemplary embodiment shown in FIG. 1, one or more input audio electrical signals 114, such as, for example, analog or digital electrical signals, are received and processed by the EQ stage 102. Equalized audio signals 116, such as, for example, analog or digital signals, are output by the EQ stage 102. The EQ stage 102 includes equalization stage control inputs 122. The operation of the EQ stage 102 and its processing of input audio electrical signals 114 are dependent at least in part upon the equalization stage control inputs 122. More particularly, dependent at least in part upon the equalization stage control inputs 122, the EQ stage 102 alters the frequency response characteristics of the audio subsystem 100. The equalization stage control inputs 122 may be, for example, digital or analog signals or other types of inputs.

The compression stage 104 receives and performs the process of compressing, using passive or active electronic elements or digital algorithms, equalized audio signals 116. Compressed audio signals 124, such as, for example, analog or digital signals, are produced as output by the compression stage 104. The compression stage 104 includes compression stage control inputs 126. The operation of the compression stage 104 and its processing of equalized audio signals 116 are dependent at least in part upon compression stage control inputs 126. More particularly, dependent at least in part upon compression stage control inputs 126, the compression stage 104 alters the compression characteristics of equalized audio signals 116 and, thus, of the audio subsystem 100.

The limiter stage 106 receives and performs the process of limiting, using passive or active electronic elements or digital algorithms, compressed audio signals 124. Limited audio signals 128, such as, for example, analog or digital signals, are produced as output by the limiter stage 106. The limiter stage 106 includes limiter stage control inputs 130. The operation of the limiter stage 106 and its processing of compressed audio signals 124 are dependent at least in part upon limiter stage control inputs 130. More particularly, dependent at least in part upon the limiter stage control inputs 130, the limiter stage 106 alters the limiting characteristics of compressed audio signals 124 and, thus, of subsystem 100.

The amplification stage 108 receives and performs the process of amplifying, using passive or active electronic elements or digital algorithms, limited audio signals 128. Amplified audio signals 132, such as, for example, analog or digital signals, are produced as output by amplification stage 108. The amplification stage 108 includes amplification stage control inputs 134. The operation of the amplification stage 108 and its processing of limited audio signals 128 are dependent at least in part upon amplification stage control inputs 134. More particularly, dependent at least in part upon the amplification stage control inputs 134, the amplification stage 108 alters the amplitude characteristics of limited audio signals 128 and, thus, of the audio subsystem 100.

The output stage 110 receives and performs the process of interfacing, using passive or active electronic elements or digital algorithms, amplified audio signals 132 to one or more output devices, such as, for example, electroacoustical transducers, output connectors, or subsequent circuitry. The output audio signals 136, such as, for example, analog or digital signals, are produced as output by the output stage 110. The output stage 110 includes output stage control inputs 138. The operation of the output stage 110 and its processing of amplified audio signals 132 are dependent at least in part upon the output stage control inputs 138.

The controller 112 is electrically connected with each of the EQ stage 102, the compression stage 104, the limiter stage 106, the amplification stage 108 and the output stage 110 and issues corresponding the stage control inputs 122, 126, 130, 134 and 138, respectively, to each. The controller 112, such as, for example, a microprocessor, executes control software 140 and receives one or more control input signals 142, each of which are more particularly described hereinafter.

Each of the audio processing stages of the audio subsystem 100, (i.e., the EQ stage 102, the compression stage 104, the limiter stage 106, the amplification stage 108 and the output stage 110, applies a respective processing characteristic or transfer function (f_{E}, f_{C}, f_{L}, f_{A}, f_{O}) to their respective audio input signals 114, 116, 124, 128 and 132 dependent at least in part upon their respective control inputs (i.e., the EQ stage control inputs 122, the compression stage control inputs 126, the limiter stage control signals 130, the amplification stage control inputs 134 and the output stage control inputs 138), all of which are issued by controller 112, to thereby produce respective output signals 116, 124, 128, 132 and, ultimately, the output audio signal 136.

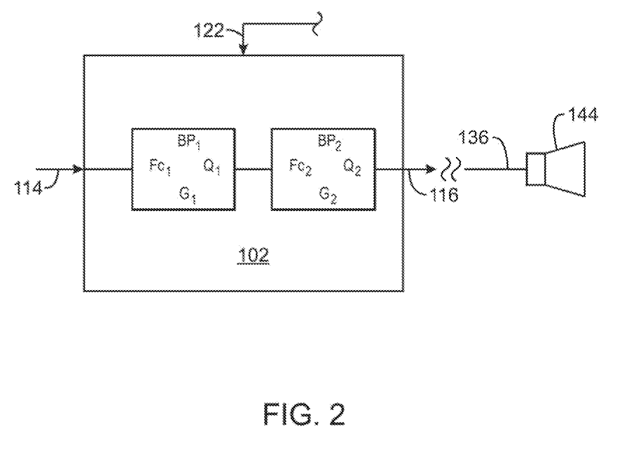

The equalization stage 102 performs the process of altering, such as, for example, by using passive or active electronic elements or digital signal processing algorithms, the frequency response characteristics of its input electrical audio signal 114. Referring now to FIG. 2, the EQ stage 102 applies to its input electrical audio signal 114 a transfer function f_{E}. Generally, the transfer function f_{E} may comprise a two-stage bandpass transfer function having first bandpass characteristics BP1 and second bandpass characteristics BP2.

More particularly, the transfer function f_{E} applies to the input electrical audio signal 114 a first bandpass characteristic BP1 having a first center frequency F_{C1}, a Q factor Q₁, and a gain level G₁. The transfer function f_{E} further applies to input electrical audio signal 114 second bandpass characteristic BP2 having a second center frequency F_{C2}, a Q factor Q₂, and gain level G₂. Each of the first and the second center frequency F_{C1} and F_{C2}, Q factors Q₁ and Q₂, and gain levels G₁ and G₂ are dependent at least in part upon the frequency response of an electroacoustical transducer or speaker 144. As used herein, the terms “electroacoustical transducer” and “speaker” are intended to include any device that reproduces a sound, including headphones, earbuds, piezoelectric elements or the like.

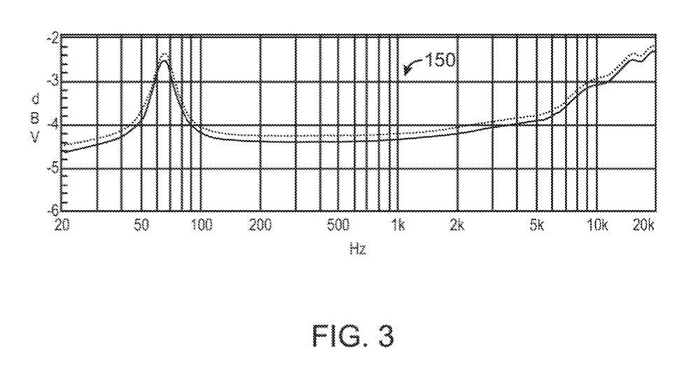

Referring now to FIG. 3, there is shown a frequency response profile (applied gain vs. frequency) 150 resulting from the application of one exemplary embodiment of the transfer function f_{E} to the input electrical audio signal 114. In this exemplary embodiment, the first bandpass characteristic BP1 of the transfer function f_{E} includes a first center frequency F_{C1} of approximately 65 Hz, a first factor Q₁ of approximately 0.5 and a first gain level G₁ of approximately +2 dB. The second bandpass characteristic BP2 of the transfer function f_{E} includes a second center frequency F_{C2} of approximately 20 kHz, a second Q factor Q₂ of approximately 1.0 and a second gain level G₂ of approximately +2 dB.

A frequency response profile (gain vs. frequency) 150 shows that the application of this exemplary embodiment of transfer function f_{E} emphasizes a range of frequencies within the audio bass frequency range from approximately 40 Hz to approximately 100 Hz and having a peak emphasis of approximately +2 dB at F_{C1} of approximately 65 Hz.

As described above, the bass frequency range may also contain a certain amount of electrical interference signals, such as, for example, ground loop currents and power source/line noise. Thus, this specific transfer function f_{E} and the frequency response profile 150 are most advantageously applied in conjunction with electronic devices and audio subsystems having an audio signal channel that is relatively free from electrical interference signals within the bass audio frequency range (i.e., an audio signal channel having a low noise floor).

The frequency response profile 150 further shows that applying this exemplary embodiment of the transfer function f_{E} also emphasizes a range of frequencies within the audio treble frequency range of from approximately 5 kHz to approximately 20 kHz and having a peak emphasis of approximately +2 dB at F_{C2} of approximately 20 kHz. Thus, when viewed as a whole, the frequency response profile 150 closely approximates an inverted frequency response curve of a typical or average human ear and/or of a typical or average level of human hearing.

This specific transfer function f_{E} and frequency response profile 150 may be applied when the output audio signals 136 are to be reproduced by one or more electroacoustical transducers or speakers having a low-frequency response that extends to approximately a first center frequency F_{C1} and a high-frequency response that similarly extends to approximately a second center frequency F_{C2}. Such a frequency response is relatively flat, such as, for example, −3 dB.

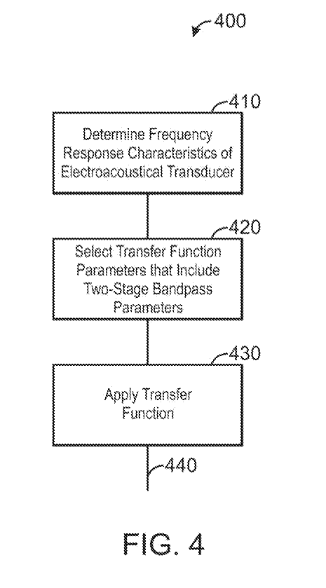

Referring now to FIG. 4, one embodiment of a method for modifying an audio signal to possess desired audio characteristics is shown. The method is generally referred to by the reference number 400.

At block 410, frequency response characteristics of a speaker are determined. Transfer function parameters that include two-stage bandpass parameters are selected, as shown at block 420. At block 430, the transfer function is applied.

The process of determining the frequency response characteristics of a speaker (block 410) may include determining the upper and lower frequencies, f_{UPPER} and f_{LOWER}, respectively, at which the output level of a particular electroacoustical transducer or speaker falls below a predetermined level or threshold, such as, for example, a level of approximately −2 dB to approximately −3 dB below the “flat” or average level. These frequencies are often referred to as “cutoff” frequencies.

The process of selecting transfer function parameters (block 420) includes selecting, dependent at least in part upon upper and lower frequency response limits f_{UPPER} and f_{LOWER}, respectively, first and second bandpass characteristics BP1 and BP2. More particularly, the process of selecting transfer function parameters (block 420) may include selecting a first center frequency F_{C1} a first Q factor Q₁ and a first gain level G₁ of the first bandpass characteristic BP1 and selecting a second center frequency F_{C2}, a second Q factor Q₂, and a second gain level G₂ of the second bandpass characteristic BP2.

The process of applying the transfer function (block 430) includes applying the dual bandpass transfer function characteristic having the transfer function parameters, i.e., F_{C1}, Q₁, G₁, F_{C2}, Q₂, and G₂ selected at block 420. The transfer function is applied to an input audio electrical signal, such as, for example, by using passive or active electronic elements or digital signal processing algorithms to thereby alter the frequency characteristics of the input audio electrical signal, and produce modified audio signal, as shown at block 440.

According to an exemplary embodiment of the present invention, the method 400 may produce an output audio signal having frequency characteristics that are tailored to and compensate for any deficiencies in the frequency response characteristics of a particular electroacoustical transducer or speaker to be used in reproducing the audible sounds corresponding to the input audio signal. Thereby, the quality and accuracy of the reproduced audio is significantly enhanced.

Exemplary embodiments of the present invention are useful to improve audio quality when electroacoustical transducers or speakers with moderate-to-high sensitivity levels are used to reproduce as audible sound any audio signal that includes electrical interference having a frequency component within the audio frequency range. Additionally, exemplary embodiments of the present invention improve audio performance when processing an audio signal in which the entire bass frequency range has been emphasized without the undesirable effects generally described as muddy or boomy, in contrast to the desirable quality described as tight and controlled.

Moreover, exemplary embodiments of the present invention selectively emphasize certain audio frequencies or ranges of audio frequencies without imparting undesirable qualities to the reproduced audio. In addition, the process of emphasizing certain audio frequencies or ranges thereof does not undesirably emphasize undesired electrical noise signals within the audio frequency range.

What is claimed is:

1. An electronic audio device that is adapted to be connected to a speaker, the electronic device comprising:
an audio subsystem that is adapted to receive an input audio electrical signal; and
an equalizer that is adapted to receive the input audio electrical signal and to apply a transfer function that comprises a two-stage bandpass function thereto to produce an output audio electrical signal, the transfer function being dependent at least in part upon a frequency response of the speaker.

2. The electronic device of claim 1, wherein the speaker comprises a portion of a set of headphones.

3. The electronic device of claim 1, wherein the transfer function includes first and second center frequencies, first and second gain factors, and first and second Q factors.

4. The electronic device of claim 3, wherein the first and second center frequencies are dependent at least in part upon corresponding first and second cutoff frequencies of the speaker.

5. The electronic device of claim 3, wherein the first and second gain factors are dependent at least in part upon a gain at each of the first and second cutoff frequencies of the speaker.

6. The electronic device of claim 3, wherein the first and second factors are dependent at least in part upon corresponding first and second rates at which the frequency response of the speaker decreases outside its first and second cutoff frequencies.

7. The electronic device of claim 3, wherein the first and second center frequencies are approximately 65 Hz and 20 kHz, respectively.

8. The electronic device of claim 3, wherein the first and second Q factors are approximately 0.5 and 1.0, respectively.

9. The electronic device of claim 3, wherein the first gain level and the second gain level are each approximately +2 dB.

10. A method of modifying an input audio electrical signal for producing sound by a speaker, the method comprising:
determining the frequency response characteristics of the speaker;
determining a transfer function that comprises a two-stage band pass transfer function, the transfer function being dependent at least in part upon the frequency response characteristics of the speaker; and
applying the transfer function to the input audio electrical signal to thereby produce a modified audio electrical output signal.

11. The method of claim 10, wherein the speaker comprises a portion of a set of headphones.

12. The method of claim 10, wherein the transfer function includes first and second center frequencies and first and second Q factors.

13. The method of claim 11, wherein the transfer function further includes first and second gain factors.

14. The method of claim 12, wherein the first and second center frequencies are approximately equal to first and second cutoff frequencies of the speaker.

15. The method of claim 12, wherein the first and second center frequencies are approximately 65 Hz and 20 kHz, respectively.
